(19) United States
(12) Patent Application Publication
(10) Pub. No.: US 2025/0315639 A1
(43) Pub. Date: Oct. 9, 2025

(54) RFID TAG COMPONENT AND TOOL INCLUDING RFID TAG COMPONENT

(71) Applicant: SHUYOU (SHANGHAI)TECHNOLOGY CO., LTD., Shanghai (CN)

(72) Inventor: Youngdo KIM, Shanghai (CN)

(21) Appl. No.: 19/174,842

(22) Filed: Apr. 9, 2025

Related U.S. Application Data
(63) Continuation of application No. PCT/CN2024/085954, filed on Apr. 3, 2024.

(51) Int. Cl. G06K 19/077; G06K 19/07

(52) U.S. Cl. CPC G06K 19/07722; G06K 19/0723; G06K 19/07758; G06K 19/07786

(57) ABSTRACT

An RFID tag component and a tool attached with the RFID tag component are disclosed, including: a substrate; a bottom layer and a middle layer which located between a top and the bottom of the substrate, one end of the middle layer electrically connected to the one end of the bottom layer through the first through hole, other end of the middle layer extending toward the other end of the RFID tag component; a top layer which located on the top of the substrate, other end of the top layer electrically connected to the other end of the bottom layer through the second through hole, one end of the top layer spaced apart from the first through hole, the top layer including a gap; a chip bonded to the top layer across the gap of the top layer.

### CROSS-REFERENCE TO RELATED APPLICATIONS

This application is a continuing application of PCT International Application No. PCT/CN2024/085954 filed on Apr. 3, 2024. The entire disclosures of the above application are all incorporated herein by reference.

### BACKGROUND OF THE DISCLOSURE

### Technical Field

The present disclosure relates to the field of the radio frequency identification, and more specifically to a radio frequency identification (RFID) tag component and a tool including the radio frequency identification tag component.

### Description of Related Art

With the development of the sensors in various frequency bands and the low-power Bluetooth technology, the RFID technology has been widely used in many industries. In a static environment, in addition to the sensitivity and the identification range issues of the RFID tags, the problem of polarization mismatch between the RFID reader antenna and the identifying item is also becoming increasingly prominent. Especially in the inventory management of the small tool libraries or the batch identification when passing through the entry-exit gates, the tools are randomly placed, and it is difficult to ensure that the tool with the RFID tag remains in a fixed position, or to ensure that the distance between the tag and the reader is approximately the same. When multiple identifying items exist in arbitrary postures and may not be placed at the predetermined location, the items of different materials placed adjacently may cause the offset of the center frequency of the RFID tag. In addition, the rotation direction of the identifying item may cause the directionality and the polarization direction of the attached RFID tag to be inconsistent, so the maximum sensing distance of the tag is limited.

When an RFID tag is attached to a symmetrical structure or a cylindrical item (such as a small tool, a wood, a furniture, and so on), it is difficult to directly confirm its arrangement position and direction from the outside when inserting the tag component.

### SUMMARY OF THE INVENTION

The present disclosure aims to overcome the above-mentioned problems in the prior art and provide a new RFID tag design that enables the RFID tag component itself to have a ground plane to minimize the deviation/offset between the forward radiation gain and the backward radiation gain. Even when used in application environments with multiple identifying objects arranged in any direction, the identification performance of batch RFID tags may be improved.

A first aspect of the present disclosure provides an RFID tag component. “One end” recited in the present disclosure may also be referred to as “first end” while “other end” recited in the present disclosure may also be referred to as “second end”. The RFID tag component includes one end and other end along a length direction. The RFID tag component further includes: a substrate, a first through hole, a second through hole, a bottom layer, a middle layer, a top layer, and a chip. The first through hole is arranged at the one end of the RFID tag component in the substrate. The second through hole is arranged at the other end of the RFID tag component in the substrate. The bottom layer is located at a bottom of the substrate. One end of the bottom layer is close to the one end of the RFID tag component. Other end of the bottom layer is close to the other end of the RFID tag component. The middle layer is located between a top and the bottom of the substrate. One end of the middle layer is electrically connected to the one end of the bottom layer through the first through hole. Other end of the middle layer extends toward the other end of the RFID tag component. The top layer is located on the top of the substrate. Other end of the top layer is electrically connected to the other end of the bottom layer through the second through hole. One end of the top layer is spaced apart from the first through hole. The top layer includes a gap. The chip is bonded to the top layer across the gap of the top layer. Moreover, a distance between the other end of the middle layer and the one end of the RFID tag component is not larger than a distance between the gap and the one end of the RFID tag component.

A second aspect of the present disclosure provides an RFID tag component, wherein the RFID tag component includes one end and other end along a length direction, and further includes: a substrate, a first through hole, a second through hole, a bottom layer, a middle layer, a chip, and a top layer. The first through hole is arranged at the one end of the RFID tag component in the substrate. The second through hole is arranged at the other end of the RFID tag component in the substrate. The bottom layer is located at a bottom of the substrate. One end of the bottom layer is close to the one end of the RFID tag component. Other end of the bottom layer is close to the other end of the RFID tag component. The middle layer is located between a top and the bottom of the substrate. One end of the middle layer is electrically connected to the one end of the bottom layer through the first through hole. Other end of the middle layer is connected to the other end of the bottom layer through the second through hole. The middle layer includes a gap. The chip is bonded to the middle layer across the gap of the middle layer. The top layer is located on the top of the substrate. One end of the top layer is spaced apart from the one end of the RFID tag component. Other end of the top layer is spaced apart from the other end of the RFID tag component. The top layer includes a mechanical hole. The mechanical hole at least partially overlaps the gap of the middle layer. The chip is accommodated in the mechanical hole.

A third aspect of the present disclosure provides a tool, which includes a cavity configured to accommodate the RFID tag component as in any one of the preceding items. The RFID tag component is arranged in the cavity along the length direction.

Other features and aspects become apparent through the following detailed descriptions, drawings, and claims.

### BRIEF DESCRIPTION OF THE DRAWINGS

FIG. 1a and FIG. 1b show a side view and an exploded view of an RFID tag component according to an embodiment of the present disclosure.

FIG. 2a and FIG. 2b show a side view and an exploded view of an RFID tag component according to another embodiment of the present disclosure.

FIG. 3a and FIG. 3b show the impedance characteristics of the RFID tag component according to one embodiment and the RFID tag component according to another embodiment of the present disclosure when various parameters are set based on the 920 MHz center frequency band of the UHF frequency band.

FIG. 3c shows a process diagram of fine-tuning the center frequency of the RFID tag component by adjusting a length D1 of the top layer.

FIG. 4a and FIG. 4b show schematic diagrams of the RFID tag components attached onto a surface of a planar tool and in a groove of a surface of a tool according to the first embodiment and the second embodiment of the present disclosure.

FIG. 4c shows a schematic diagram of an RFID tag component attached onto the surface of the tool in the opposite direction according to the third embodiment of the present disclosure.

FIG. 5a shows the radiation pattern of the RFID tag component in the cross-sectional direction when the RFID tag components according to the first embodiment and the second embodiment of the present disclosure are attached onto a surface of a planar tool and in a groove of a surface of a tool.

FIG. 5b shows the radiation pattern in the cross-sectional direction when the RFID tag component according to the second embodiment of the present disclosure is attached to tools having different widths and grooves of the same depths.

FIG. 6 shows that when the RFID tag component of the third embodiment of the present disclosure is attached to a tool, the performance changes of the identifiable distance of the tag when the tool rotates around its axis in the length direction.

FIG. 7 shows a schematic diagram of the RFID tag component which is arranged into a tool according to the fourth embodiment of the present disclosure.

FIG. 8 shows the radiation pattern of the RFID tag component in the cross-sectional direction when the RFID tag component is inserted into the tool at multiple angles according to the fourth embodiment of the present disclosure.

FIG. 9 shows the performance changes of the identifiable distance of the tag as the angle changes when the RFID tag component according to the fourth embodiment of the present disclosure is inserted into the tool at multiple angles.

The drawings are only for illustrative purposes and are not to be regarded as to scale unless proportionality is specifically stated. The drawings are provided as schematics to aid understanding and may not include all aspects or information when compared with actual representations.

In the drawings, similar components and/or features may have the same reference numerals. Various components of the same type may be distinguished by letters following the reference numerals. If only a preceding reference number is used in the specification, the description applies to any similar component with the same preceding reference number.

### DETAILED DESCRIPTION

In order to make the above objects, features, and advantages of the present disclosure clearer and more understandable, the embodiments of the present disclosure are described in detail below with reference to the accompanying drawings.

Many specific details are set forth in the following description in order to fully understand the present disclosure. However, the present disclosure may also be implemented in other ways different from those described here. Those skilled in the art may make similar extensions without violating the features of the present disclosure. Therefore, the present disclosure is not limited by the specific embodiments disclosed below.

Moreover, the present disclosure is described in detail with reference to schematic diagrams. When describing the embodiments of the present disclosure in detail, for the convenience of explanation, the cross-sectional views showing the apparatus structure are partially enlarged to different proportions. The schematic diagrams are only embodiments, which should not limit the scope of protection of the present disclosure. In addition, the three-dimensional dimensions of length, width, and depth should be included in the actual production.

Specific embodiments of the present disclosure will be described below. It should be noted that during the specific description of these embodiments, for the purpose of concise description, it is impossible for the specification to describe in detail all features of the actual embodiments. It should be understood that during the actual implementation of any implementation, just as in the process of any engineering or design project, various specific decisions are often made in order to achieve the developer's specific goals and to meet system-related or business-related constraints, and this will also change from one implementation to another. In addition, it may also be understood that although the efforts made in this development process may be complicated and lengthy, for those of ordinary skill in the art related to the contents disclosed in the present disclosure, some design, manufacturing, or production changes based on the technical contents disclosed in the present disclosure are only conventional technical means and should not be understood as insufficient content of the present disclosure.

Unless otherwise defined, technical terms or scientific terms used in the claims and the specification should have the usual meanings understood by a person of ordinary skills in the technical field to which the present disclosure belongs. The words “first”, “second”, and similar words used in the specification and the claims of the present disclosure do not indicate any order, quantity, or importance, but are only used to distinguish different components. “A” or “one” and similar words do not imply a quantitative limitation but rather indicate the presence of at least one. Words such as “include” or “comprise” mean that the component or the object appearing before the word “include” or “include” includes components or objects listed after the word “include” or “include” and their equivalent components, and do not exclude other components or objects. Words such as “connect” or “connected” are not limited to physical or mechanical connections, nor are they limited to direct or indirect connections.

In the present disclosure, unless otherwise specified, all embodiments, preferred embodiments, all technical features, and preferred features mentioned herein may be combined with each other to form new technical solutions.

In the embodiment of the present disclosure, the term “and/or” is only an association relationship describing associated objects, indicating that three relationships may exist, such as A and/or B, which may mean: An alone exists, A and B exist simultaneously, and B alone exists. In addition, the character “/” in the present disclosure generally indicates that the related objects are an “or” relationship.

As the usage scenarios of the RFID tags expand in various industrial fields, in addition to the readable identification distance of the RFID tags in the static environments, the versatility of the RFID tags which may cope with various environments and variables in actual application sites has also become very important. In particular, when it is difficult to intuitively confirm the tag attachment position from the outside due to the inherent appearance characteristics of the object to which the RFID tag is attached, or when the RFID tag is inserted into a specific space within the attached object in order to protect the RFID tag from the influence of the external environment and for the stability of attachment, it is almost impossible to achieve an optimal identification state of the RFID reader antenna and the identifying object. During the storage, movement, or packaging of the objects, especially in the large warehouses, the RFID tags are placed in any direction or on shelves at different heights. At this time, the omnidirectional identification capability of the tag is the key to ensure the stability of the RFID system. Therefore, when the RFID tags are arranged at high locations on conductive shelves in the large warehouses, high identification rates and flexibility may be maintained using the RFID readers on the ground if the forward radiation gain, the backward radiation gain, and the side radiation gain of the tag are similar. The technical solutions provided by the present disclosure may reduce the scattering, interference, and interference of radio waves when batch multiple objects which pass through the access control are identified, and may significantly improve the identification performance of the tag of the object in any direction or rotation direction.

The core advantage of the ultra-high frequency (UHF) passive RFID tag technology is its ability to utilize the backscattering communication protocol to identify multiple tags simultaneously over long distances without contact. The characteristics of the ultra-high frequency electromagnetic waves cause the loss and the dielectric constant of the material to which the tag is attached to have a significant impact on the performance of the tag. The spatial radiation gain pattern of the tag is not only affected by its own design, but is also closely related to the object to which the tag is attached, its location, the polarization matching of the reader antenna, and the surrounding electromagnetic environment. When the tag is attached to a dielectric material (such as plastic, glass, or ceramic with a high dielectric constant), a dipole-shaped tag forms a uniform radiation pattern around the insertion axis when inserted into these materials. Although the specific radiation gain is affected by the material loss and the dielectric constant, the spatial omnidirectional (Omni) radiation pattern of the tag remains roughly unchanged as long as the symmetry of the material is maintained.

In practical applications, when a tag is attached to a dielectric material and the radiation gain of the tag is required to be concentrated in a specific direction (usually the front), making the tag have a grounding function or coating the tag with additional conductive medium, and maintaining an appropriate spacing, may be considered.

When an RFID tag needs to be tightly attached to a metal surface, it is usually necessary to perform the complex impedance matching with the chip of the tag and to arrange a ground plane on the tag. Although this method may conveniently use the ground plane of the tag together with the metallic conductive medium as the ground plane, the input impedance bandwidth of the tag may be reduced, and the electrical characteristics of the tag may be significantly affected by the size of the conductive medium and the attachment location. In addition, due to the asymmetry of the ground plane, the radiation pattern of the tag may deviate greatly. When the size of the attaching metal object is relatively large, the radiation gain of the tag tends to be concentrated in the upper part of the ground plane. When the tag is attached to a conductive object having a larger area, the difference in radiation gain between the front (facing the reader) and the back is significant compared to the size of the tag. This difference is particularly noticeable between the front of the tag and the back of the conductive object.

To improve this biased radiation gain pattern, one method is to machine the metal material itself into disconnected or closed-loop slots that serves as a part of the tag antenna. However, the radiation gain of this method is relatively low, and it is difficult to arbitrarily process the metal objects in practical applications. In addition, there are difficulties in the final packaging process including the chip molding, so this method is not used widely.

When an RFID reader identifies an RFID tag, in order to achieve the maximum readable distance, it should be ensured that the cross-sectional area (radar cross-section, RCS) of the RFID tag faces the radiation area of the reader antenna as much as possible. Most RFID tags designed for use on metal surfaces are designed to direct the maximum radiation gain toward the front direction perpendicular to the metal surface. However, when the tag is not at the same height as the reader antenna or the tag is attached to at an oblique angle, the RCS decreases sharply and the receiving sensitivity is significantly reduced. In the applications of managing the high-rise shelves in the logistics warehouses or preventing the product loss on the shelves, in addition to the identification performance of the tags in a stationary state, a wider radiation gain angle is also an important factor. Furthermore, when multiple tagged objects are placed in arbitrary directions rather than in the uniform front-facing direction, maintaining a uniform radiation pattern of the tags on a specific plane is critical to improve the utility of the RFID system.

When the polarization of the RFID reader antenna and the tag which is attached to the metal surface are inconsistent, and the radiation gain of the tag is biased to a specific direction, the identification rate of the tag may change significantly with the identification angle of the reader antenna. This results in a significant reduction in the batch identification rate when multiple identifying objects are loaded in arbitrary directions.

Therefore, there is a need for an RFID tag component that may maintain the performance of the tag when attached to the conductive object and the dielectric object, and may enable the radiation gain of the tag to maintain a uniform radiation pattern in a specific direction when the conductive object and the dielectric object are in any direction, thereby improving the usability of the RFID tag in practical application environments.

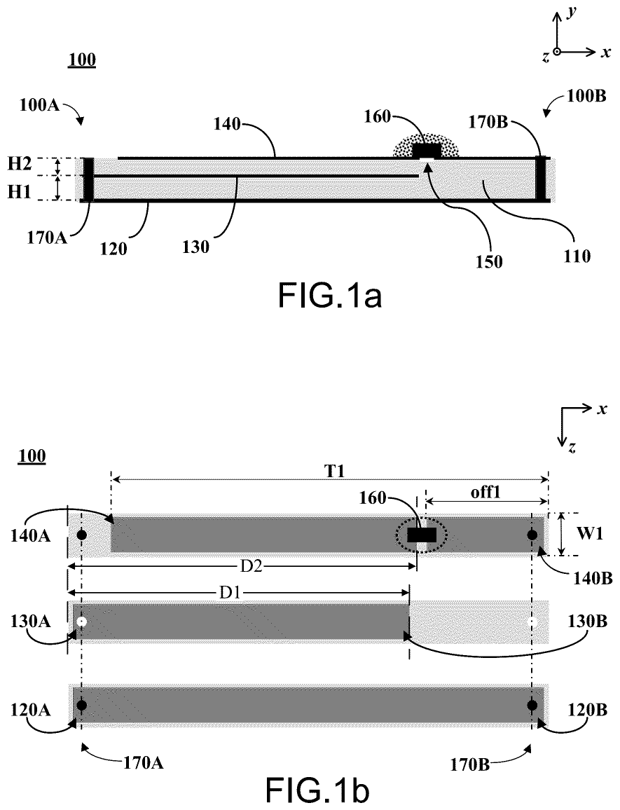

FIG. 1a and FIG. 1b show a side view and an exploded view of an RFID tag component 100 according to an embodiment of the present disclosure. The RFID tag component 100 includes one end 100A and other end 100B along a length direction (the x-axis shown in FIG. 1a). The RFID tag component 100 includes a substrate 110, a bottom layer 120, a middle layer 130, and a top layer 140. The substrate 110 may be made of a dielectric material. The bottom layer 120, the middle layer 130, and the top layer 140 may be made of a conductive material (such as copper) and fabricated into a very thin sheet. The bottom layer 120 is located at a bottom of the substrate 110 and extends along the length direction of the RFID tag component 100. One end 120A of the bottom layer 120 is close to the one end 100A of the RFID tag component 100. Other end 120B of the bottom layer 120 is close to the other end 100B of the RFID tag component 100. The middle layer 130 is located between a top and the bottom of the substrate 110. One end 130A of the middle layer 130 is close to the one end 100A of the RFID tag component 100. Other end 130B of the middle layer 130 extends toward the other end 100B of the RFID tag component 100. The top layer 140 is located on the top of the substrate 110. Other end 140B of the top layer 140 is close to the other end 100B of the RFID tag component 100. One end 140A of the top layer 140 extends toward the one end 100A of the RFID tag component 100 without reaching the one end 100A of the RFID tag component 100. The top layer 140 and the middle layer 130 are at least partially overlapped in the longitudinal direction (the y-axis in FIG. 1a); namely, a projection of the top layer 140 onto the bottom layer 120 is at least partially overlapped with a projection of the middle layer 130 onto the bottom layer 120. Additionally, the top layer 140 further includes a gap 150. The chip 160 of the RFID tag component 100 is bonded to the top layer 140 across the gap 150. Preferably, the chip 160 is covered with a protective layer such as epoxy resin.

A distance D1 between the other end 130B of the middle layer 130 and the one end 100A of the RFID tag component 100 is not larger than a distance D2 between the gap 150 and the one end 100A of the RFID tag component 100.

In addition, the RFID tag component 100 further includes a first through hole 170A (which is arranged in the substrate 110 at the one end 100A of the RFID tag component 100) and a second through hole 170B (which is arranged in the substrate 110 at the other end 100B of the RFID tag component 100). The through hole structures may be manufactured by the mechanical processing, and then a conductive material (such as copper) is coated on the inner surfaces of the through hole structures to enable conduction between different objects electrically connected to the conductive material, thereby forming the through holes. The first through hole 170A connects the one end 130A of the middle layer 130 to the one end 120A of the bottom layer 120. The second through hole 170B connects the other end 140B of the top layer 140 to the other end 120B of the bottom layer 120.

In the embodiment shown in FIG. 1a and FIG. 1b, the bottom layer 120 serves as a ground layer of the RFID tag component 100. There is a spacing of H1 between the bottom layer 120 and the middle layer 130 (for example, through the first through hole 170A). The spacing between the middle layer 130 and the top layer 140 is H2. There is a spacing of H1+H2 between the bottom layer 120 and the top layer 140 (for example, through the second through hole 170B). This three-dimensional structure of the RFID tag component 100 may effectively reduce the area of the tag component in the limited space, and by making the top layer 140 and the middle layer 130 closely coupled in a disconnected manner instead of a short-circuit connection, the working impedance bandwidth of the RFID tag component 100 is improved and the adjustability is provided.

The center frequency may be adjusted by changing various design variables of the RFID tag component 100, such as the spacing H1 between the bottom layer 120 and the middle layer 130, the spacing H2 between the middle layer 130 and the top layer 140, a position of the other end 130B of the middle layer 130, a length T1 of the top layer 140, a position of the chip 160 on the top layer 140 (here, indicated by a distance off1 between the chip 160 and the other end 140B of the top layer 140), and so on. In the assembly state, it is difficult to adjust the spacing H1 between the bottom layer 120 and the middle layer 130, the spacing H2 between the middle layer 130 and the top layer 140, and the position of the other end 130B of the middle layer 130. In the case that the distance D1 between the other end 130B of the middle layer 130 and the one end 100A of the RFID tag component 100 exceeds the distance D2 between the gap 150 and the one end 100A of the RFID tag component 100, even very subtle changes in other variables may greatly affect the center frequency of the RFID tag component 100. Therefore, this embodiment predetermines the distance D1 between the other end 130B of the middle layer 130 and the one end 100A of the RFID tag component 100 to not exceed the distance D2 between the gap 150 and the one end 100A of the RFID tag component 100. In FIG. 1a, the other end 130B of the middle layer 130 is basically aligned with a side of the gap 150 closer to the one end 100A of the RFID tag component 100. Furthermore, the spacing H1 and the spacing H2 are predetermined, and the center frequency and the impedance matching of the RFID tag component 100 are fine-tuned by fine-tuning the position off1 of the chip 160 and the length T1 of the top layer 140.

In addition, a width W1 of the RFID tag component 100 is designed to be very narrow compared to its length. Therefore, the equivalent capacitance formed by the close coupling between the top layer 140 and the middle layer 130 which is realized through the bottom layer 120 and the connected through holes 170A and 170B on both sides may relatively easily achieve the complex impedance matching of the chip 160 of the RFID tag component. And by having the RFID tag component 100 itself with a ground plane, the RFID tag component 100 may be attached to a metal surface or inserted into a metal environment and various dielectric materials.

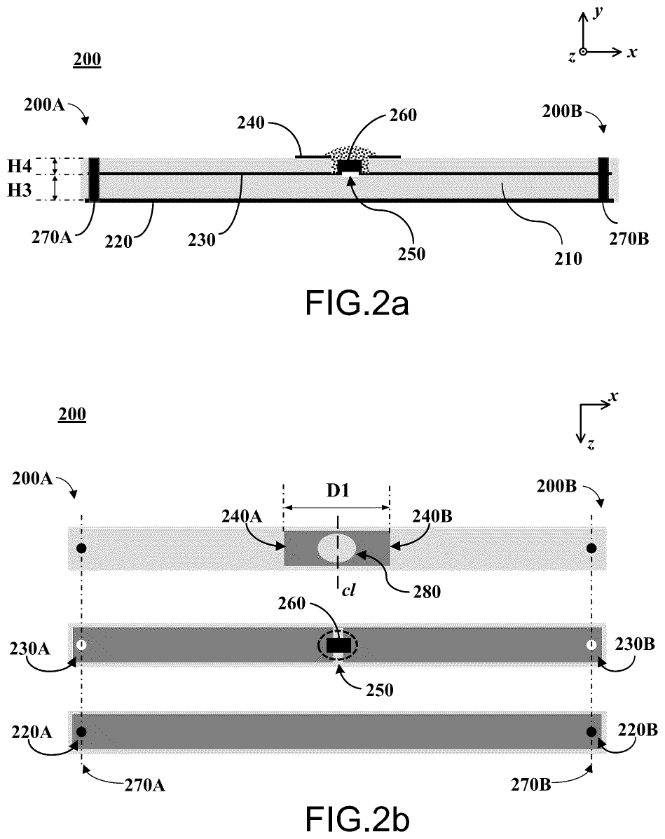

FIG. 2a and FIG. 2b show a side view and an exploded view of an RFID tag component 200 according to another embodiment of the present disclosure. The RFID tag component 200 includes one end 200A and other end 200B along a length direction (the x-axis). The RFID tag component 200 includes a substrate 210, a bottom layer 220, a middle layer 230, and a top layer 240. The substrate 210 may be made of a dielectric material. The bottom layer 220, the middle layer 230, and the top layer 240 may be made of a conductive material (for example, copper) and fabricated into a very thin sheet. The bottom layer 220 is located at a bottom of the substrate 210 and extends along the x-axis direction. One end 220A of the bottom layer 220 is close to the one end 200A of the RFID tag component 200. Other end 220B of the bottom layer 220 is close to the other end 200B of the RFID tag component 200. The middle layer 230 is located between a top and the bottom of the substrate 210. One end 230A of the middle layer 230 is close to the one end 200A of the RFID tag component 200. Other end 230B of the middle layer 230 is close to the other end 200B of the RFID tag component 200. The middle layer 230 includes a gap 250. The gap 250 is located at a middle position of the middle layer 230 in the x-axis direction. The chip 260 of the RFID tag component 200 is bonded to the middle layer 230 across the gap 250. The chip 260 may be covered with a protective layer. The top layer 240 is located on the top of the substrate 210. One end 240A of the top layer 240 is spaced apart from the one end 200A of the RFID tag component 200. Other end 240B of the top layer 240 is spaced apart from the other end 200B of the RFID tag component 200. The top layer 240 includes a mechanical hole 280 which at least partially overlaps the gap 250 of the middle layer 230 in the longitudinal direction (the y-axis in FIG. 2a). The chip 260 and an optional protective layer of the chip 260 may be accommodated in the mechanical hole 280. The mechanical hole 280 defines a cavity structure in the top layer 240, thereby conveniently arranging the chip 260 in the middle layer 230 and playing a role in avoiding and protecting the chip 260. Preferably, the top layer 240 is symmetrical with respect to a midline cl of the RFID tag component 200 in the x-axis direction. The top layer 240 and the middle layer 230 are at least partially overlapped in the longitudinal direction (the y-axis in FIG. 2a).

In addition, the RFID tag component 200 further includes a first through hole 270A (which is arranged at the one end 200A of the RFID tag component 200 in the substrate 210) and a second through hole 270B (which is arranged at the other end 200B of the RFID tag component 200 in the substrate 210). The first through hole 270A connects the one end 230A of the middle layer 230 to the one end 220A of the bottom layer 220. The second through hole 270B connects the other end 230B of the middle layer 230 to the other end 220B of the bottom layer 220.

In the embodiment shown in FIG. 2a and FIG. 2b, the bottom layer 220 serves as a ground layer of the RFID tag component 200. There is a spacing of H3 between the bottom layer 220 and the middle layer 230. There is a spacing of H4 between the middle layer 230 and the top layer 240. A length D1 of the top layer 240 along the x-axis direction may be used as a design variable. As the material of the attached object and the attached depth change, the RFID tag component 200 may be fine-tuned by adjusting the design variable D1. When the length D1 of the top layer 240 increases, the equivalent capacitance between the top layer 240 and the middle layer 230 increases, thereby reducing the center frequency of the RFID tag component 200. Conversely, when the length D1 decreases, the equivalent capacitance decreases, thereby increasing the center frequency of the RFID tag component 200. This sheet-like structure of the top layer 240 may easily improve the deviation/offset caused by the changes in the surrounding environment outside the RFID tag component 200 and the changes in the arrangement environment. In addition, it may also reduce the protrusion of the top of the RFID tag component 200, reduce the friction during the arrangement process, and improve the convenience. The structure shown in this embodiment may be used as a technical solution that may efficiently and conveniently implement the impedance matching of the chip in the UHF frequency band through the conventional PCB manufacturing processes.

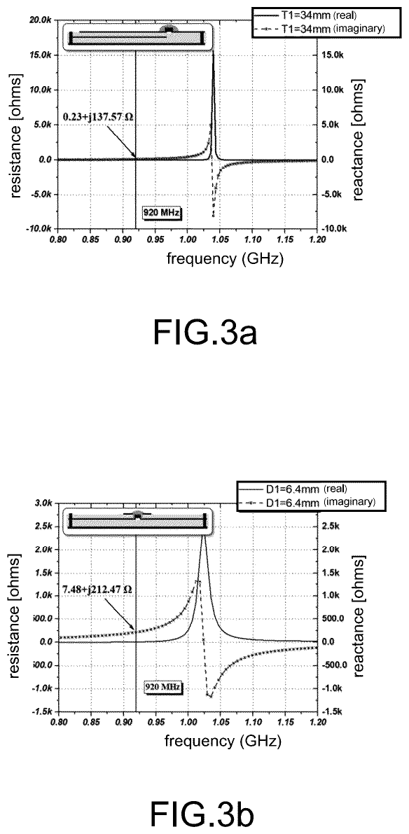

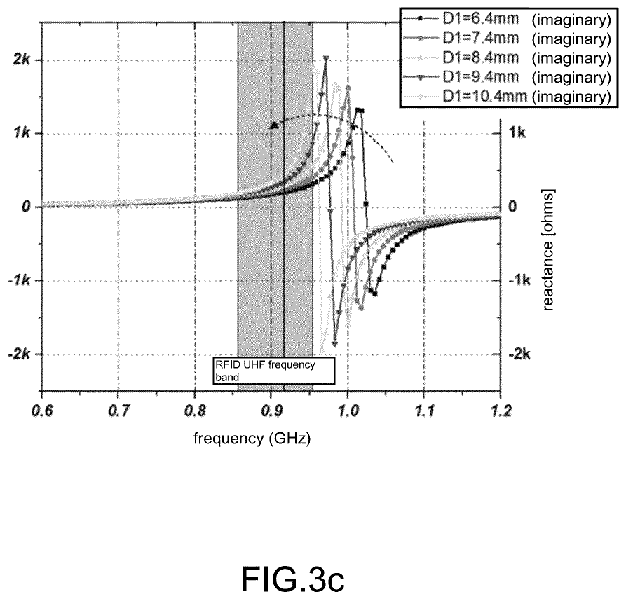

FIG. 3a and FIG. 3b show the impedance characteristics of the RFID tag component 100 according to one embodiment and the RFID tag component 200 according to another embodiment of the present disclosure when various parameters are set based on the 920 MHz center frequency band of the UHF frequency band. As shown in FIG. 3a and FIG. 3b, the imaginary component of the input impedance of the RFID tag component 100 is a relatively low 0.23+j137.57Ω (f₀=920 MHz), and the imaginary component of the input impedance of the RFID tag component 200 is set to a relatively high 7.48+j212.47Ω (f₀=920 MHz). The most critical design variable of the RFID tag components 100/200 of the present disclosure is the distance between the through holes arranged on both sides of the RFID tag component (the distance between the through hole 170A and the through hole 170B, the distance between the through hole 270A and the through hole 270B, hereinafter referred to as the “through hole spacing”) and the spacing between each layer in the multi-layer RFID tag component (the spacing H1 and the spacing H2 in the RFID tag component 100, and the spacing H3 and the spacing H4 in the RFID tag component 200, hereafter referred to as the “spacing between layers”). The through hole spacing is the most important design variable for adjusting the inductance component of the RFID tag component. The spacing between layers is the most important design variable for adjusting the capacitance of the RFID tag component. However, the thickness of the RFID tag component, the thickness of each layer, and the length of each layer through the through hole, which serve as these design variables, may not be significantly changed after the manufacturing process of the RFID tag component is determined; only other means may be used for fine-tuning.

The RFID tag component 100 in FIG. 1a and FIG. 1b may adjust the electrical parameters of the RFID tag component 100 by adjusting the length T1 of the top layer 140 and the bonding position off1 of the chip 160. The RFID tag component 200 in FIG. 2a and FIG. 2b may achieve fine-tuning of the center frequency of the RFID tag component 200 by adjusting the length D1 of the top layer 240. FIG. 3c schematically shows the process of fine-tuning the center frequency of the RFID tag component 200 by adjusting the length D1 of the top layer 240. This fine-tuning of the design variables of the RFID tag component provides the convenient means to easily fine-tune the changes and the tolerances in the materials of various attached objects. As an embodiment, the input impedances of the RFID tag component 100 and the RFID tag component 200 of the present disclosure are formed to be 0.23+j137.57Ω and 7.48+j212.47Ω respectively based on 920 MHz. It may be seen that the imaginary input impedance which needs to be redesigned as the chip changes may be adjusted by adjusting the distributed area, thus improving the usability of the RFID tag component.

Generally, the RFID tag component itself attached onto the metal surface includes a ground plane. When the ground plane is connected to the metal surface in a short-circuit manner, the attached metal surface itself serves as the common ground plane of the RFID tag component. Therefore, when the area of the attached metal object is large, the radiation gain and the spatial radiation pattern of the RFID tag component may also be greatly affected as the attached position changes. There are significant differences in the radiation gain patterns between the front side and the back side of the RFID tag component attached onto the metal object. In order to improve the aesthetics and reduce the risk of the damage to the RFID tag component in practical applications, the RFID tag component is generally embedded in a groove on the metal surface. As the depth of the groove increases, the radiation efficiency of the tag component decreases, and the spatial radiation gain decreases, which in turn affects its identification distance.

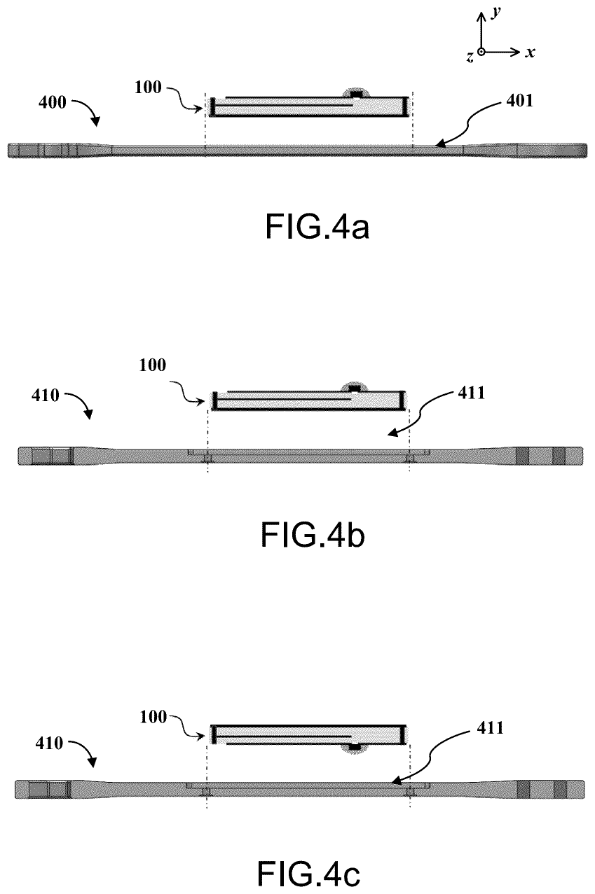

FIG. 4a shows a schematic diagram of the RFID tag component 100 attached onto a planar tool 400 according to the first embodiment of the present disclosure. Moreover, the RFID tag component 100 includes a protruding chip, which may be covered by a protective layer. The tool 400 is made of narrow and long metal. The planar surface 401 of the tool 400 is not provided with any cavity or groove for accommodating the RFID tag component 100.

FIG. 4b shows the RFID tag component 100 attached onto the surface of the tool 410 according to the second embodiment of the present disclosure. FIG. 4c shows the RFID tag component 100 attached onto the surface of the tool 410 in the opposite direction according to the third embodiment of the present disclosure. In FIG. 4b to FIG. 4c, the RFID tag component 100 includes a protruding molded protected chip, and the tool 410 is made of narrow and long metal. The surface of the tool 410 is provided with a groove 411 for accommodating the RFID tag component 100.

The tool may be made of metal or other materials such as dielectric materials, plastic, or wood. For the convenience of testing and simulation experiments, a wrench is shown here as a representative tool, but tools of other materials are also suitable. FIG. 4a to FIG. 4c illustrate the arrangement of the RFID tag component 100 in FIG. 1a to FIG. 1b on the tool 400 and the tool 410. Those skilled in the art may understand that the RFID tag component 200 in FIG. 2a to FIG. 2b may also be arranged on the tool 400 and the tool 410 in the manner shown in FIG. 4a to FIG. 4c. As shown in FIG. 4c, when the RFID tag component is arranged in the opposite direction, the chip part is placed in the groove on the metal surface, and is not exposed to the outside, which effectively reducing the risk of the damage to the RFID tag component caused by environmental factors. When the RFID tag component 100 is selected and used, the chip 160 preferably protrudes from the top layer 140 to a certain height. This may increase the thickness of the protective layer, form a certain distance between the surface of the groove 411 and the top layer of the RFID tag component 100, and form additional equivalent capacitance, which may be used as an additional parameter to adjust the center frequency of the RFID tag component 100. By adjusting the distance between the RFID tag component 100 and the surface of the groove 411 (such as by changing the thickness of the protective layer), the center frequency of the RFID tag component 100 may be adjustable.

Compared with the prior art, the RFID tag component of the present disclosure may significantly reduce the difference between the forward radiation gain and the backward radiation gain under different attachment conditions, whether attached to a metal object or a material with different dielectric constants.

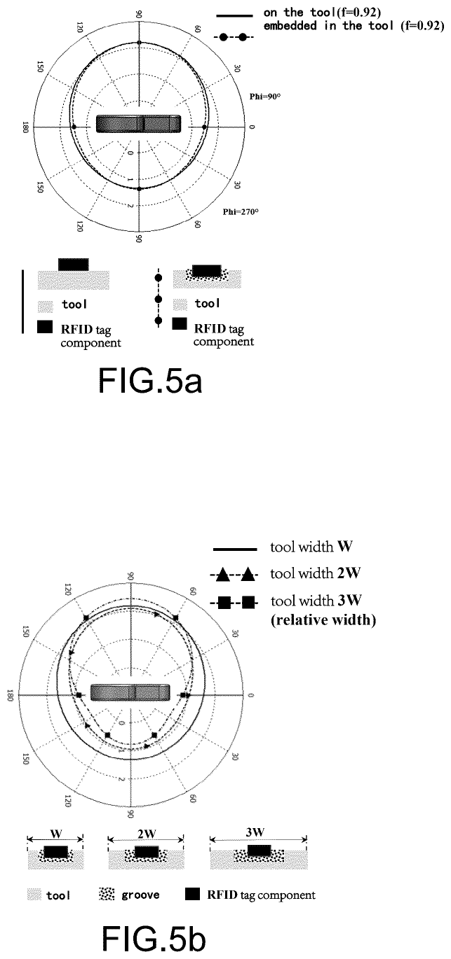

FIG. 5a shows the radiation pattern of the RFID tag component 100 in the cross-sectional direction when the RFID tag components 100 according to the first embodiment and the second embodiment of the present disclosure are attached onto a flat surface 401 of the tool 400 (FIG. 4a) and in a groove 411 on a surface of the tool 410 (FIG. 4b). As an embodiment, the groove 411 is set to have a depth of 0.4 mm-0.8 mm, but the present disclosure is not limited thereto. Here, the cross-section refers to a plane perpendicular to the length direction; namely, a plane defined by the y-axis and the z-axis in FIG. 4a. Using 920 MHz as the reference frequency, the RFID tag component 100 exhibits a radiation gain of 2.2 dBi in the front (+y direction) and 1.3 dBi in the back (−y direction) when attached to the surface 401 and embedded in the groove 411. In the side direction, the side radiation gain of the RFID tag component 100 attached onto the surface 401 is 1.6 dBi, while that of the RFID tag component 100 embedded in the groove 411 is 1.5 dBi. Although the back radiation gain is 0.9 dBi lower than the front radiation gain, this difference between the front radiation gain and the back radiation gain is significantly reduced compared to the tag attached onto the conventional metal surface.

FIG. 5b shows the radiation pattern in the cross-sectional direction when the RFID tag component 100 according to the second embodiment of the present disclosure is attached in grooves 411 (having the same depths) of tools (having different widths). Normally, an RFID tag component with a ground plane shows a trend of increasing front radiation gain and decreasing back radiation gain as the metal area of the attached tool increases. FIG. 5b shows the radiation pattern data when the tool width is W, 2W, and 3W (wherein W is the reference width). The differences in the front radiation gain under different widths is 0.1 dBi to 0.3 dBi, while the differences in the back radiation gain under different widths is 0.3 dBi to 0.5 dBi. This radiation pattern deviation/offset caused by different tool widths is considered to have little impact on the readable identification distance performance of the RFID tag component in actual application environments.

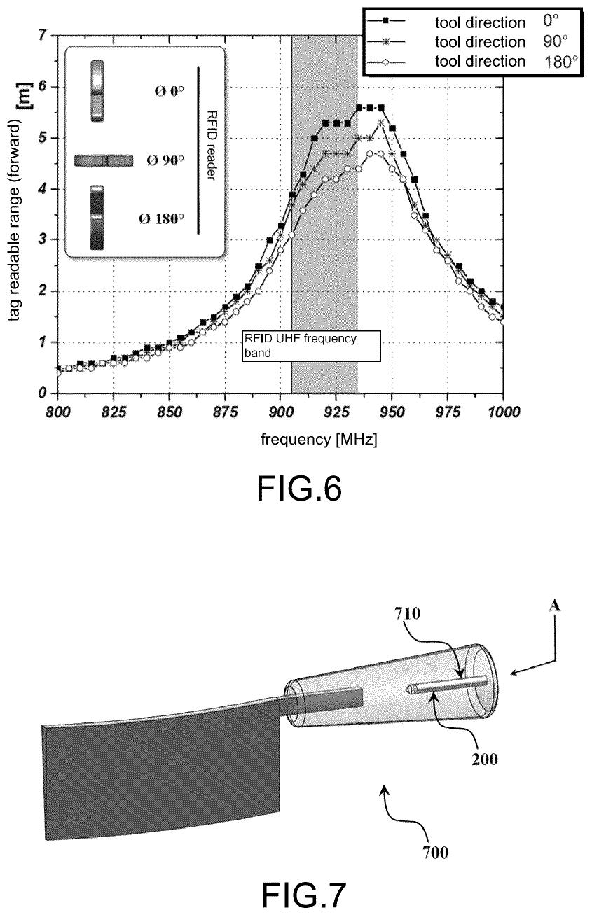

FIG. 6 shows that when the RFID tag component 100 of the third embodiment of the present disclosure is attached to the tool 400 (FIG. 4c), the performance changes of the identifiable distance of the RFID tag component 100 when the tool 400 rotates around its axis in the length direction (x-axis direction). As shown in the upper left corner of FIG. 6, the direction of the tool 400 when the front radiation direction of the RFID tag component 100 faces the RFID reader is defined as 0°, the direction of the tool 400 when the front radiation direction of the RFID tag component 100 is perpendicular to the direction from the tool 400 to the RFID reader is defined as 90°, and the direction of the tool 400 when the back radiation direction of the RFID tag component 100 faces the RFID reader is defined as 180°. It may be seen that the maximum identifiable distance performance of the RFID tag component 100 is optimal when the tool 400 is at 0° relative to the RFID reader. When the direction is rotated to 90°, the maximum identifiable distance of the RFID tag component 100 decreases by 0.5m. When the tool 400 is rotated to 180° relative to the RFID reader, the maximum identifiable distance of the RFID tag component 100 decreases by another 0.5m. However, this difference has little impact in practical application environments.

For tools or furniture made of different dielectric materials, when using an RFID system for asset management, RFID tag components may be embedded in the dielectric materials. The embedded arrangement method not only protects the RFID tag components from harsh environments, but also improves the appearance of the tool. Since the RFID tag component may have a radiation gain preference in a specific direction, and its direction and position inside the tool may not be visually determined, when an RFID reader is used to read from the outside, not all tools with embedded tags may face the reader. Therefore, the uniform radiation gain characteristics of RFID tag components are particularly important when identifying multiple tools in any direction.

FIG. 7 shows a schematic diagram of the RFID tag component 200 which is arranged into a tool 700 according to the fourth embodiment of the present disclosure. The tool 700 is made of a dielectric material. The RFID tag component 200 may be first arranged in a middleware 710, and then the middleware 710 and the RFID tag component 200 may be inserted into the tool 700 together.

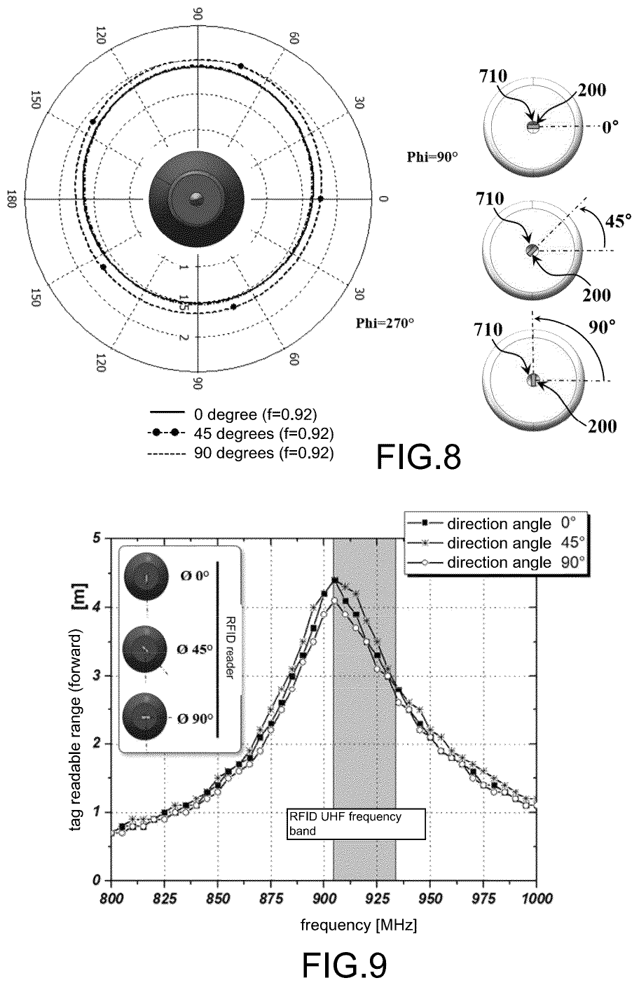

FIG. 8 shows the radiation pattern of the RFID tag component 200 in the cross-sectional direction when the RFID tag component 200 is inserted into the tool 700 at different/multiple angles according to the fourth embodiment of the present disclosure. Shown on the left side of FIG. 8 is a bottom view of the tool 700 as viewed from the perspective A shown in FIG. 7. The angles between the plane on which the RFID tag component 200 is located (a plane defined by the x-axis and the z-axis in FIG. 2b) and the reference horizontal plane of the tool are 0°, 45°, and 90° respectively. When the RFID tag component 200 is inserted into the tool 700 at 0°, 45°, and 90° respectively, the ground plane of the RFID tag component 200 faces the RFID reader in front, inclined, and side directions respectively. As shown on the right side of FIG. 8, as the measurement results of the RFID tag component 200 being inserted into the tool 700 at 0°, 45°, and 90°, when inserted at 45°, the spatial radiation gain is relatively high, but the difference is about 0.1 dBi compared with the cases when inserted at 0° and 90°. The measurement results shown in FIG. 8 indicate that large radiation deviations/offset may not occur with changes in insertion angle in practical application environments.

FIG. 9 shows the performance changes of the identifiable distance of the RFID tag component 200 as the angle of the RFID tag component 200 changes when the RFID tag component 200 according to the fourth embodiment of the present disclosure is inserted into the tool 700 at different/multiple angles. The relative direction between the reference horizontal plane of the tool 700 and the RFID reader remains unchanged in the drawing. By changing the insertion direction of the RFID tag component 200 within the tool 700, the RFID tag component 200 rotates around its longitudinal axis (the x-axis in FIG. 2a). When the RFID tag component is arranged in the tool 700 at 0°, 45°, and 90° with the reference horizontal plane of the tool 700, its maximum identifiable distance performance does not change much. It may be seen that the RFID tag component provided in the present disclosure has uniform radiation characteristics in all directions.

The RFID tag component 200 is shown in the description and drawings of FIG. 7 to FIG. 9, and the RFID tag component 100 as shown in FIG. 1a to FIG. 1b may also be arranged.

The present disclosure relates to a special RFID tag component that may minimizes the difference between the forward radiation gain and the backward radiation gain of the RFID tag component. Accordingly, the identification distance deviation/offset of a tool attached with the RFID tag component in any direction is small, and the identification distance deviation/offset when multiple tools are arranged in any direction is small, thereby improving the identification rate of the RFID tag component.

The RFID tag component of the present disclosure forms a laminated structure by arranging through holes at both ends to reduce the size of the tag, and controls the coupling capacitance with the ground plane of the bottom layer to adjust the complex impedance matching of the RFID tag component chip, which is achieved by coupling the top layer and the middle layer and the ground plane of the bottom layer in an interdigitated structure, or maintaining a certain distance. Such a structural design exposes the sensitive design variables which adjust the center frequency of the RFID tag to the outside, making it easy to adjust the electrical performance of the RFID tag according to changes and errors in the attached object. In addition, the chip of the RFID tag component is arranged in an embedded manner to form a low-profile shape, which not only reduces the risk of the damage caused by the external environment, but also improves the aesthetics. In the multilayer PCB structure, the spacing between different layers is an important design variable for the electrical performance and the effective tag matching of the RFID tag component, providing multiple adjustment possibilities.

The technical solution of the present disclosure aims to achieve the complex impedance matching between the conductive medium and the tag chip, and reduce the size of the tag, and the tag includes a ground plane, so that it may be widely used in objects with different dielectric constants, high dielectric liquids in specific containers, and conductive materials. In particular, the laminated PCB manufacturing technology common in electronic circuits is used to construct the structural characteristics of this tag, achieving precise and standardized production of low-cost and general-purpose tags.

Some exemplary embodiments are described above. However, it should be understood that various modifications may be made to the above-described exemplary embodiments without departing from the spirit and the scope of the present disclosure. For example, if the described techniques are performed in a different order and/or if the components of the described systems, architectures, apparatuses, or circuits are combined differently and/or replaced or supplemented by additional components or their equivalents, suitable results may also be achieved, and other modified embodiments are also within the protection scope of the claims.

What is claimed is:

1. An RFID tag component, characterized in that the RFID tag component comprises one end and other end along a length direction, and further comprises:
a substrate;
a first through hole, arranged at the one end of the RFID tag component in the substrate;
a second through hole, arranged at the other end of the RFID tag component in the substrate;
a bottom layer, located at a bottom of the substrate, one end of the bottom layer close to the one end of the RFID tag component, other end of the bottom layer close to the other end of the RFID tag component;
a middle layer, located between a top and the bottom of the substrate, one end of the middle layer electrically connected to the one end of the bottom layer through the first through hole, other end of the middle layer extending toward the other end of the RFID tag component;
a top layer, located on the top of the substrate, other end of the top layer electrically connected to the other end of the bottom layer through the second through hole, one end of the top layer spaced apart from the first through hole, the top layer comprising a gap; and
a chip, bonded to the top layer across the gap of the top layer, wherein a distance between the other end of the middle layer and the one end of the RFID tag component is not larger than a distance between the gap and the one end of the RFID tag component.

2. The RFID tag component of the claim 1, wherein a length of the top layer and/or a length of the middle layer are/is adjustable to adjust a center frequency of the RFID tag component.

3. The RFID tag component of the claim 1, wherein the other end of the middle layer is aligned with a side of the gap close to the one end of the top layer.

4. The RFID tag component of the claim 1, wherein a projection of the middle layer onto the bottom layer is at least partially overlapped with a projection of the top layer onto the bottom layer.

5. An RFID tag component, characterized in that the RFID tag component comprises one end and other end along a length direction, and further comprises:
a substrate;
a first through hole, arranged at the one end of the RFID tag component in the substrate;
a second through hole, arranged at the other end of the RFID tag component in the substrate;
a bottom layer, located at a bottom of the substrate, one end of the bottom layer close to the one end of the RFID tag component, other end of the bottom layer close to the other end of the RFID tag component;
a middle layer, located between a top and the bottom of the substrate, one end of the middle layer electrically connected to the one end of the bottom layer through the first through hole, other end of the middle layer connected to the other end of the bottom layer through the second through hole, the middle layer comprising a gap;
a chip, bonded to the middle layer across the gap of the middle layer;
a top layer, located on the top of the substrate, one end of the top layer spaced apart from the one end of the RFID tag component, other end of the top layer spaced apart from the other end of the RFID tag component, the top layer comprising a mechanical hole, the mechanical hole at least partially overlapping the gap of the middle layer, the chip accommodated in the mechanical hole.

6. The RFID tag component of the claim 5, wherein the gap is located at a middle position of the middle layer in a direction from the one end of the middle layer to the other end of the middle layer.

7. The RFID tag component of the claim 5, wherein a projection of the top layer onto the bottom layer is at least partially overlapped with a projection of the middle layer onto the bottom layer.

8. The RFID tag component of the claim 5, wherein the top layer is symmetrical with respect to a midline between the one end and the other end of the RFID tag component.

9. The RFID tag component of the claim 5, wherein a length of the top layer is adjustable to adjust a center frequency of the RFID tag component.

10. A tool, characterized in that the tool comprises an RFID tag component, wherein the RFID tag component comprises one end and other end along a length direction, and further comprises:
a substrate;
a first through hole, arranged at the one end of the RFID tag component in the substrate;
a second through hole, arranged at the other end of the RFID tag component in the substrate;
a bottom layer, located at a bottom of the substrate, one end of the bottom layer close to the one end of the RFID tag component, other end of the bottom layer close to the other end of the RFID tag component;
a middle layer, located between a top and the bottom of the substrate, one end of the middle layer electrically connected to the one end of the bottom layer through the first through hole, other end of the middle layer extending toward the other end of the RFID tag component;
a top layer, located on the top of the substrate, other end of the top layer electrically connected to the other end of the bottom layer through the second through hole, one end of the top layer spaced apart from the first through hole, the top layer comprising a gap; and
a chip, bonded to the top layer across the gap of the top layer,
wherein a distance between the other end of the middle layer and the one end of the RFID tag component is not larger than a distance between the gap and the one end of the RFID tag component; and
the tool further comprises a cavity configured to accommodate the RFID tag component; the RFID tag component is arranged in the cavity with the length direction of the RFID tag component parallel to an axial direction of the tool.

11. The tool of the claim 10, wherein a length of the top layer and/or a length of the middle layer are/is adjustable to adjust a center frequency of the RFID tag component.

12. The tool of the claim 10, wherein the other end of the middle layer is aligned with a side of the gap close to the one end of the top layer.

13. The tool of the claim 10, wherein a projection of the middle layer onto the bottom layer is at least partially overlapped with a projection of the top layer onto the bottom layer.

14. A tool, characterized in that the tool comprises an RFID tag component, wherein the RFID tag component comprises one end and other end along a length direction, and further comprises:
a substrate;
a first through hole, arranged at the one end of the RFID tag component in the substrate;
a second through hole, arranged at the other end of the RFID tag component in the substrate;
a bottom layer, located at a bottom of the substrate, one end of the bottom layer close to the one end of the RFID tag component, other end of the bottom layer close to the other end of the RFID tag component;
a middle layer, located between a top and the bottom of the substrate, one end of the middle layer electrically connected to the one end of the bottom layer through the first through hole, other end of the middle layer connected to the other end of the bottom layer through the second through hole, the middle layer comprising a gap;
a chip, bonded to the middle layer across the gap of the middle layer; and
a top layer, located on the top of the substrate, one end of the top layer spaced apart from the one end of the RFID tag component, other end of the top layer spaced apart from the other end of the RFID tag component, the top layer comprising a mechanical hole, the mechanical hole at least partially overlapping the gap of the middle layer, the chip accommodated in the mechanical hole,
wherein the tool further comprises a cavity configured to accommodate the RFID tag component; the RFID tag component is arranged in the cavity with the length direction of the RFID tag component parallel to an axial direction of the tool.

15. The tool of the claim 14, wherein the gap is located at a middle position of the middle layer in a direction from the one end of the middle layer to the other end of the middle layer.

16. The tool of the claim 14, wherein a projection of the top layer onto the bottom layer is at least partially overlapped with a projection of the middle layer onto the bottom layer.

17. The tool of the claim 14, wherein the top layer is symmetrical with respect to a midline between the one end and the other end of the RFID tag component.

18. The tool of the claim 14, wherein a length of the top layer is adjustable to adjust a center frequency of the RFID tag component.
